(19) United States
(12) Patent Application Publication
(10) Pub. No.: US 2004/0047536 A1
(43) Pub. Date: Mar. 11, 2004

(54) Creep and viscous flow resistant fiber optic sensor

(76) Inventors: Gary R. Pickrell, Blacksburg, VA (US); Anbo Wang, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/653,921

(22) Filed: Sep. 4, 2003

Related U.S. Application Data
(60) Provisional application No. 60/407,981, filed on Sep. 5, 2002.

(51) Int. Cl. G02B 6/00

(52) U.S. Cl. 385/12; 356/477

(57) ABSTRACT

Viscous flow and volume consolidation which may cause sensor output drift are avoided in a fiber optic sensor by using a body of crystalline and preferably monocrystalline material to establish the transducer gap. Use of a monocrystalline material also reduces chemical reactivity of the sensor with substances which may be present where the sensor is deployed. The increased dimensional stability of the monocrystalline body in a tube-based, V-groove-based or other type of fiber optic sensor reduces the need for and frequency of recalibration.

### CROSS-REFERENCE TO RELATED APPLICATIONS

This application claims priority of U. S. Provisional Patent Application Serial No. 60/407,981, filed Sep. 5, 2002, entitled “Creep and Viscous Flow Fiber Optic Sensor” which is hereby fully incorporated by reference.

### BACKGROUND OF THE INVENTION

1. Field of the Invention

The present invention generally relates to fiber optic sensors for measuring parameters such as temperature and pressure and the like and, more particularly, to fiberoptic sensors which resist long-term effects of temperature and pressure and which may thus be allowed to remain in service for long periods without need for recalibration.

2. Description of the Prior Art

Fiber optic sensors have been known for a number of years and are much preferred for making remote measurements of temperature, pressure and other conditions such as strain, flow rate, shear forces and the like, particularly in harsh environments. Performing telemetry using radiant energy carried by fiber optic light guides is inherently free from electromagnetic noise and interference and has proven highly reliable. Moreover, very small, inexpensive and highly robust sensors have been developed which are easily calibrated and provide extremely high sensitivity and accuracy through use of interferometric techniques.

Many designs for fiber optic interferometric sensors are known and many variations and implementations have been developed. However, the basic arrangement of the most successful of these designs generally involve the formation of a reflective surface near the end of a fiber optic cable which is used to both supply light to the sensor from a remote location and return light to the remote location after it is passed through the sensor. The basic principle of operation of such sensors is that the end of the fiber optic cable provides a partially reflecting surface allowing some light to pass to and be reflected by a further reflective surface spaced a very short distance from the end of the fiber optic cable thus forming a gap between reflecting surfaces. The sensor is configured in such a way that the length of the gap is variable with the parameter of interest. Thus the light reflected from the respective surfaces will have two components; one delayed with respect to the other and which may be discriminated by, for example, wavelength or, preferably, form an interference pattern in which regions of reinforcement or cancellation will be observable and which will vary strongly with potentially minute changes in the gap length. Other arrangements using other phenomena such as wavelength separation are also known.

To provide for the gap length to be reliably established while allowing variation thereof with any of a plurality of parameters of interest, the sensor structure of choice generally and most basically comprises a tube with optical fibers inserted into opposite ends thereof to be aligned in close proximity while forming a gap and the tube bonded to the respective optical fibers to fix the relative positions of the optical fibers. Other structure for locating the fiber optic and reflector such as so-called V-groove sensor plates (where two ends of optical fiber are seated in a V-shaped groove on a generally planar surface of a substrate; a construction often preferred for strain gauges and other applications where the sensor is bonded to or otherwise mounted on a surface) are also known and others will be apparent to those skilled in the art.

Whatever structure is employed, particularly involving tubes, fused silica glass is commonly used for fiber-positioning structures as a matter of convenience in manufacture and economy while allowing inspection of the interior of the sensor for contamination, tube cracking, alteration of alignment, gap length and the like. Also, since such a structure will respond with a change of gap length to temperature, pressure and strain, the internal configuration and materials of the sensor may be altered to maximize response to one of these stimuli while minimizing response to others. Use of a glass tube often allows sensors thus differentiated in function to be distinguished by inspection. This structure has proven quite adequate for most telemetry applications even in very harsh environments such as in deep gas and oil wells, engine telemetry and the like.

However, this structure presents two points of potential instability: the bond of the glass tube to the optical fibers and the glass tube, itself. Neither of these effects has been experimentally quantified or even to be reasonably predictable in progress. In general, the instability of the bond is much the smaller of the two since the distance over which the instability can occur is generally very small. On the other hand, Fused silica glass is known to be subject to viscous flow when subjected to even small forces over an extended period of time which can change the geometry of the tube in a direction tending to relieve forces thereon and, consequently, the sensor gap length. Further, fused silica glass will invariably exhibit variation in density which largely corresponds to cooling rate and will densify or increase in density under conditions of elevated temperature and/or pressure. Without wishing to be held to any particular theory underlying this phenomenon, fused silica is thought to contain microscopic voids generated by contraction during cooling during the formation of the tube, the bonding process or both. These voids may spontaneously collapse over time in a process referred to as volume consolidation and which can be accelerated by temperature and/or pressure; resulting in unpredictably altered geometry of the tube relied upon to maintain sensor gap length.

As the use of fiber optic sensors becomes more widespread and applied to increasingly harsh environments such as oil wells, turbine engines, boilers and the like where high temperatures and pressures are generally present, the consequences of these effects have become of increased severity and less susceptible of being remedied. Consider that a small but persistent change occurs over time in the geometry of the glass tube in a basic fiber optic sensor as described above resulting in a slight shortening of the tube and the gap by an unknown amount. The sensor is not rendered inoperable but a small change in the output of the sensor which is not related to changes in the measured parameter will have been induced slowly over time. This change is sometimes referred to as drift. Full accuracy and sensitivity of the sensor may be restored through recalibration although additional drift may occur over time.

If the sensor is operated under only moderately harsh conditions and removed from such conditions and recalibrated with reasonable frequency, very high accuracy and sensitivity may be maintained indefinitely. However, current applications of interest may involve telemetry from a well which may have a depth of several miles, economically precluding removal from service and recalibration except on a very infrequent basis. At the same time, extremely harsh and continuous conditions of increased temperature, pressure and/or strain encountered in such applications have been found to substantially accelerate both viscous flow and volume consolidation in sensors of conventional sensor construction such that significant errors and drift may occur under tensile loading over as short a period as several weeks; a much shorter period than is economically feasible for removal and recalibration of a sensor so deployed. It is to be expected that similar effects will occur in comparable degree under compressive loading, as well, and may be even less predictable, particularly at the point that substantially full densification is reached through volume consolidation. Further, no technique for in-situ recalibration has been devised to date or is anticipated since the conditions of interest cannot generally be removed or artificially varied while the sensor remains in place.

Additionally, while fused silica glass is substantially chemically inert in most environments, it remains subject to some chemical processes such as oxidation, nitridization and etching which may be favored by some conditions of harsh environments, particularly when the chemicals which may contact it may vary widely. Gas diffusion into fused silica glass may also occur. Any of these processes or others which may not be presently recognized may add material to the glass or leach material from it, either of which carries the potential for dimensional change of the tube.

The problem of viscous flow and volume consolidation of the fused silica or other material in fiber optic sensors is not limited to tube-based sensors but, in general, the problem will extend to any other types of sensors using fused silica or other material having similar attributes of viscous flow and/or volume consolidation, depending on the criticality of the dimensional stability of the component in which fused silica is used and the criticality of the measurement to be made. As such, tube-based sensors, diaphragm-based sensors, V-groove sensors and the like, will all suffer the same problem as long as they include elements made of glass.

### SUMMARY OF THE INVENTION

It is therefore an object of the present invention to provide a fiber-optic sensor structure which is simple, economical and robust but which is not subject to drift.

It is another object of the invention to provide a fiber-optic sensor of improved stability and which does not require periodic calibration even under continuous harsh conditions of use.

In order to accomplish these and other objects of the invention, a telemetry system and fiber optic sensor therefor are provided wherein the fiber optic sensor includes a body of crystalline material, a fiber optic element having an end surface and bonded to the body of crystalline material, and a reflective surface positioned by the body of crystalline material at a location separated from said end surface of said fiber optic element to form a gap.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a cross-sectional view of a conventional fiberoptic sensor,

FIGS. 2A and 2B illustrate mechanisms of long term drift in fiber-optic sensors such as that of FIG. 1 due to strain and pressure, respectively,

FIG. 3 is a cross-sectional view of a fiber-optic sensor in accordance with the invention, and

FIGS. 4, 5 and 6 are cross-sectional illustrations of a tube-based diaphragm sensor and a tube-in-tube based diaphragm sensor and a plan view of a V-groove optical fiber sensor, respectively.

### DETAILED DESCRIPTION OF A PREFERRED EMBODIMENT OF THE INVENTION

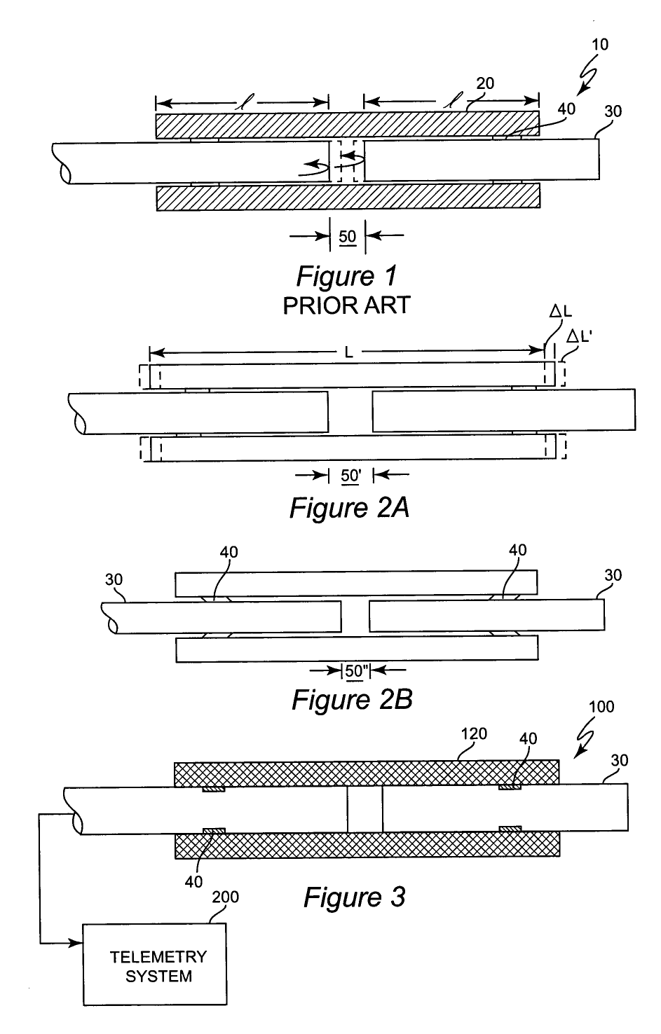

Referring now to the drawings, and more particularly to FIG. 1, there is shown a conventional structure of a fiber-optic sensor 10. As alluded to above, the body of the sensor is formed of a fused silica tube 20. A length of fiber optic material 30 is inserted in each end of the tube and fixed in position by bonds 40 which are preferably of short length along the tube but may be placed at any location along length l. In general, a greater separation of the bonds 40 will favor sensing of strain or together with a large differential of coefficients of thermal expansion (CTE) between the fiber optic material and the tube material will favor sensing of temperature (e.g. relative to pressure) while a good match of CTE and reduced separation will favor sensing of pressure relative to strain and temperature. That is, by adjustment of the geometry and material properties, relative sensitivities of the length of gap 50 to strain, temperature and pressure may be altered at will within relatively broad ranges. If different sensors are provided for temperature, pressure and/or strain, cross-calibration can be performed to develop very precise corrections for effects of conditions other than the condition of interest of each sensor.

In the following discussion of FIGS. 2A and 2B it should be appreciated that while effects of strain and pressure on the sensor of Prior Art FIG. 1 is illustrated, no admission is made that the effects illustrated are similarly prior art. Therefore, FIGS. 2A and 2B are not labelled as being Prior Art in regard to the present application.

FIG. 2A illustrates the effects of stress or strain applied to the structure of FIG. 1 in the direction of the axis of tube 20. In this case, the magnitude of the stress or strain causes elastic elongation of the tube by AL and the tube will contract to its original dimensions if the stress or strain is removed. If, however, the stress or strain is persistent, viscous flow will occur and a persistent elongation of the tube 20 will occur. That is, if the stress is removed after viscous flow occurs, the tube 20 will not return to its original dimensions and will have a length approximating L+&L while, if the stress remains, the length of the tube will continue to increase toward AL due to the viscous flow and increasing strain will be indicated even though a measurement of stress will drift. Other scenarios and their effects on the sensor will be evident to those skilled in the art. In summary, while strain will be accurately indicated, the associated stress will drift due to viscous flow.

This effect may be partially counteracted by volume consolidation or volume consolidation may be inhibited by the stress and/or strain.

A perhaps more serious effect may be that resulting from high pressure as indicated in FIG. 2B. In this case, high fluid pressure is imposed on all surfaces of the sensor and the sensor is elastically deformed in all directions causing it to assume a smaller overall size and possibly slightly altered proportions. Further, the pressure forces acting on tne fiber optic elements 30 tend to drive them farther into the tube and may distort the bonds 40 in shear, as shown. All of these effects tend to narrow the gap 50″ and all are subject to viscous flow if the pressure is maintained for an extended period. Moreover, compressive forces from pressure (which are often in the presence of high temperatures in well-bore telemetry and the like) may accelerate volume consolidation which also tends to narrow gap 50″. Both of these effects tend to make the compressed size of the sensor persistent; causing a measurement drift toward reporting higher pressure than is imposed on the sensor.

Referring now to FIG. 3, the invention solves these problems by using a tube 120 of a crystalline material and preferably monocrystalline material (indicated by cross-hatching in FIG. 3. Crystalline material presents a highly stable internal crystal lattice structure which is not subject to viscous flow and would be expected to be free from voids and substantially maximum density, as discussed above, which may give rise to volume consolidation. Therefore, a monocrystal tube is not subject to persistent dimensional changes or resultant sensor output drift due to viscous flow and/or volume consolidation which cannot be distinguished from a change in the measured parameter by telemetry system 200 or the like. Further, a monocrystalline structure does not present grain boundaries along which other materials may more easily diffuse and possibly react with the tube material.

Any crystalline material answering the above considerations is suitable for practice of the invention and a wide choice of materials is available, providing a wide choice of coefficients of thermal expansion which can be closely matched to or widely divergent from the CTE of the material of the fiber optic elements to favor stress, strain, temperature or pressure measurement sensitivity while suppressing sensitivity to the other(s). Even if a polycrystalline and/or less than maximally dense crystal structure is utilized in accordance with the invention, leaving some possibility of some finite persistent dimensional change of the sensor, that change will be small and predictably limited, possibly allowing in-situ recalibration if drift is detected for the simple reason that such drift will also be limited in magnitude and will stabilize at a characteristic having a known relationship to the prior calibration. Likewise, no constraint is imposed upon sensor geometry for adjusting relative sensitivity among measurement parameters which alter the sensor gap. The modulus of elasticity will be greater and the crystalline material somewhat more stiff relative to fused silica glass. However, the sensitivity imparted by interferometric techniques renders the slight reduction of sensor dimensional change with change of measured parameter to be, generally, of no practical importance and far less than the sensor drift which may occur in a conventional fused silica glass sensor over a very short period of time of perhaps hours or days. If any objectionable reduction of sensitivity is observed by direct substitution of crystalline material in existing designs, the thickness of the crystalline material may be reduced (e.g. proportionally to the difference in modulus of elasticity) to match the characteristics of any sensor design using fused silica glass as an element for positioning the optical fiber.

Exemplary materials suitable and preferred for practice of the invention include but are not limited to single crystal sapphire, single crystal zirconia, single crystal spinel, and single crystal quartz. The optical elements can be formed in a variety of shapes and with a variety of different techniques, depending on the final sensor design. In the case of tube-based optical sensors, the single crystal material would be fabricated in the shape of a tube of appropriate size (internal and external diameters and length).

The crystalline material of choice will depend upon the physical or chemical parameter to be sensed and the environment of the application. For example, for tube-based temperature sensors, a material with a large coefficient of thermal expansion (CTE) or a large differential CTE relative to the optical fiber within the sensor, may be desirable to effect a large dimensional change per unit change in temperature. In other cases a lower CTE or differential CTE might be desired to minimize temperature dependence such as would be desirable for a pressure or strain sensor. Similarly, other material properties, such as susceptibility to particular chemical reactions, might dictate the choice of one material over another for a particular application.

In view of the foregoing, it is seen that by the simple expedient of using a crystalline tube (preferably monocrystalline) material for the fiber optic positioning sensor tube in a fiber optic sensor, viscous flow, volume consolidation and other potential effects which can cause sensor output drift can be greatly reduced in a self-limiting manner or eliminated altogether. The sensor in accordance with the invention is thus far more stable and does not require periodic recalibration, or, if desired, only infrequently, even while continuously exposed to extremely harsh conditions (e.g. of temperature and pressure) for extended periods of time with little, if any, penalty in sensitivity. The invention may be implemented very economically with little, if any, cost increase over conventional sensors and with no change in design, dimension or manufacturing process changes other than in the manufacture of the crystalline tube, itself.

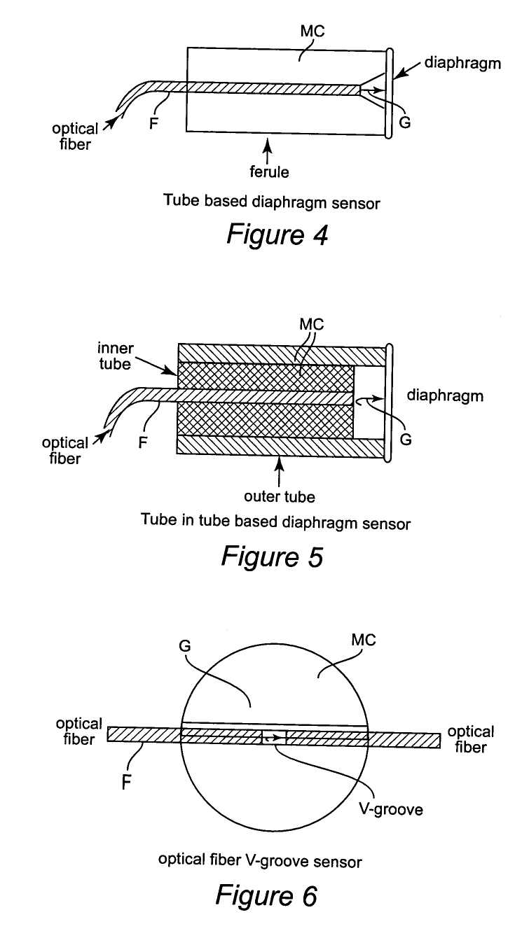

Further, as will be appreciated by those skilled in the art in view of the above discussion of the invention, the problems engendered by viscous flow and/or volume consolidation which have been encountered in tube-based fiber optic sensors will extend to other types of fiber optic sensors including but not limited to diaphragm-type sensors, V-groove structure sensors (such as the geometries and structures illustrated in FIGS. 4, 5 and 6, in which “F” designates the fiberoptic element, “G” indicates the sensor gap, and “MC” indicates the monocrystalline element in accordance with the invention establishing the gap), all extrinsic and intrinsic glass-based sensors and any other type of sensor which may include an element including an amorphous or polycrystalline material for positioning an optical surface. The invention provides a solution to sensor output drift due to viscous flow and volume consolidation while reducing the need for frequent recalibration and reduced material interactivity with the environment by the simple expedient of employing a crystalline material for any element of amorphous material found to engender any of the above-noted problems. While polycrystalline material will provide a solution to viscous flow and volume consolidation problems of amorphous materials in accordance with the invention, monocrystalline materials will provide further advantages over polycrystalline materials.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A fiber optic sensor comprising
a body of crystalline material,
a fiber optic element having an end surface, said fiber optic element being bonded to said body of crystalline material, and
a reflective surface positioned by said body of crystalline material at a location separated from said end surface of said fiber optic element to form a gap.

2. A fiber optic sensor as recited in claim 1, wherein a coefficient of thermal expansion of said crystalline material is matched to a coefficient of thermal expansion of said fiber optic element.

3. A fiber optic sensor as recited in claim 1, wherein the difference between a coefficient of thermal expansion of said crystalline material and a coefficient of thermal expansion of said fiber optic element is maximized.

4. A fiber optic sensor as recited in claim 1, wherein said body of crystalline material is in the form of a tube.

5. A fiber optic sensor as recited in claim 1, further including a diaphragm providing said reflective surface.

6. A fiber optic sensor as recited in claim 1, wherein said body of crystalline material is a substantially planar substrate having a groove in a surface thereof.

7. A fiber optic sensor as recited in claim 1, wherein said crystalline material is monocrystalline material.

8. A telemetry system including a fiber optic sensor, said fiber optic sensor comprising
a body of crystalline material,
a fiber optic element having an end surface, said fiber optic element being bonded to said body of crystalline material, and
a reflective surface positioned by said body of crystalline material at a location separated from said end surface of said fiber optic element to form a gap.

9. A fiber optic sensor as recited in claim 8, wherein a coefficient of thermal expansion of said crystalline material is matched to a coefficient of thermal expansion of said fiber optic element.

10. A fiber optic sensor as recited in claim 8, wherein the difference between a coefficient of thermal expansion of said crystalline material and a coefficient of thermal expansion of said fiber optic element is maximized.

11. A fiber optic sensor as recited in claim 8, wherein said body of crystalline material is in the form of a tube.

12. A fiber optic sensor as recited in claim 8, further including a diaphragm providing said reflective surface.

13. A fiber optic sensor as recited in claim 8, wherein said body of crystalline material is a substantially planar substrate having a groove in a surface thereof.

14. A fiber optic sensor as recited in claim 8, wherein said crystalline material is monocrystalline material.
